(19) United States
(12) Patent Application Publication
(10) Pub. No.: US 2008/0172464 A1
(43) Pub. Date: Jul. 17, 2008

(54) Generation of contextual information in communication between parties

(75) Inventors: Balaji T. Thattai, Sunnyvale, CA (US); S. Srinivasan, Cupertino, CA (US)

Correspondence Address: Raj Abhyanker, LLP;c/o Intellevate, P.O. Box 52050, Minneapolis, MN, 55402, US

(73) Assignee: NthID Networks, Inc.

(21) Appl. No.: 11/653,060

(22) Filed: Jan. 12, 2007

(51) Int. Cl. G06F 15/16

(52) U.S. Cl. 709/205

(57) ABSTRACT

A method, system and apparatus of generation of contextual information in communication between parties are disclosed. In one embodiment, a method of a communication system includes expressing an interaction between a particular user and user in a shared page such that the shared page includes documents, events, and/or communications relevant in communications between the particular user and the at least one other user and generating the shared page such that the interaction relevant to a communication between the particular user and the at least one user are manifested across a plurality of persona profiles in activities, events, and/or communications associated with in the shared page. In addition, the method may include embedding any groups and/or users common to the particular user and the user through an nth-degree separation in the shared page, and displaying a relationship simultaneously in the shared page.

### FIELD OF TECHNOLOGY

This disclosure relates generally to the technical fields of communications and, in one example embodiment, to a method, system and apparatus of generation of contextual information in communication between parties.

### BACKGROUND

A user may communicate with another user (e.g., or a set of other users) across different contexts. For example, Bill may know Jane at an office as a co-worker who works with Bill on market research. Bill may also know Jane after work as a person who shares similar culinary interests. Five years previously, Bill may have known Jane as a college friend. However, communications between Bill and Jane may have moved from those which used a university intranet system five years ago, to a social network (e.g., MySpace®) for personal communications, and/or work email for work communications (e.g., Microsoft® Outlook).

A calendaring system (e.g., Microsoft® Outlook calendar) of the user may keep track of all activities of the user with other parties. The user may see a unified view of all their activities in the calendar. The user may have to manually search each and every calendar entry to find entries from specific users such as Jane. This may be time consuming and/or inefficient. Furthermore, the calendaring system may only be tied to one of the particular modes of communication of the user. For example, Bill may have a calendar for his work activities with Jane, a different calendar on his web based email system (e.g., Google® Gmail) for personal communications with Jane, and/or a third calendar (e.g., a paper notebook) for his communications during their university years. As such, the user may have difficulty determining in which context communications have occurred between him/her and the other user in the past, recent, and/or current time-interval without manually searching through a number of disparate sources of information.

### SUMMARY

A method, system and apparatus of generation of contextual information in communication between parties are disclosed. In one aspect, a method of a communication system includes expressing an interaction between a particular user and user in a shared page (e.g., the shared page may be filterable based on a temporal criteria specified by the particular user across granularities, time zones, and/or daily routines) such that the shared page includes documents, events, and/or communications relevant in communications between the particular user and any one of the other user, and generating the shared page such that the interaction relevant to a communication between the particular user and the user are manifested across any number of persona profiles in activities, events, and/or communications associated with in the shared page.

In addition, the method may include embedding any groups and users common to the particular user and the user through an nth-degree separation in the shared page, and displaying a relationships simultaneously in the shared page. The method may include customizing the shared page based on a relationships modality of the particular user with other users based on a specialized facet determined based on a behavior and association of the particular user including a family facet having a family relationships constructor, a work facet having an organization chart constructor, and a social facet having an activity classifier to enable the particular user to manifest specialized facets in context of a particular scenario of communications.

Also, the method may include generating a set of private notes of the particular user about the at least one user in a relationships annotation module associated and linked with the shared page. The method may further include organizing a preferred ranking of specific documents, events, and communications relevant in communications between the particular user and the other user based on a behavior of the particular user and a feedback rating provided of the particular user by other parties.

The method may also include generating a digest of relevant sections of the specific communications such that the relevant sections capture a critical message of communication between the particular user and the other user including a subject-line less message and/or a last paragraph text. Furthermore, the method may include determining a segmentible calendar in the shared page that illustrates visually interaction solely between the particular user and combination of a user and/or non-user.

The method may include alternating between the shared page and other shared pages while maintaining a relationships between the particular user and the other user which is independent of any one of the persona profiles currently utilized. In addition, the method may include shuffling a priority order in the shared page based on feedback ratings calculated through intelligence gathered from personal representation of the particular user to other users, perception of the other users, behavior analysis of the particular user and linked other users through a relationship behavior compounding algorithm, and collective contact rating of peers.

Furthermore, the method may include rising enabling facets through the feedback ratings that are created through implicit and explicit techniques based on trust, affinity, and/or propensity of interaction and in which multiple facets coexist in each persona profile and which develop a set of rankings of the particular user with the other users through each of the facets. The method may include generating a life map in the shared page of the particular user and the other user in which differing activities and behaviors of the particular user are simultaneously expressed in the shared page.

Also, the method may include organizing the life map around common marker selected between people communications, events, groups, places, messages, money, and/or content including music, books, and/or news feeds. The method may further include expressing a faceted and fragmented identity of the particular user through each of the persona profiles in which a context may be provided to each social interaction of the particular user with the other user.

In another aspect, a communications system includes a network, any number of content modules each having an embedded communication module to manage relationships between a user and other users of each the content modules and a shared context module in a management module to communicate through the network with the content modules and/or to generate a shared page having captured interaction in each of the content modules between a particular user and other user based on a behavior of the particular user associated with each of the content modules with the other user through an analysis of self expressed and peer expressed feedback.

Also, the communications system may include a feedback module of the management module to analyze intelligence gathered from personal representation of the particular user to the other users, perception of the other users, behavior analysis of the user and linked other users through a relationship behavior compounding algorithm, and/or collective contact rating of peers to determine an order of display of a unitary user profile in the management module of each of groups in the embedded communication module.

In addition, the communications system may also include a vault module in which an invisible communication group may be viewable simultaneously with a confidential communication group and/or a public communication group through a multi-layer authentication technique enabled through the management module.

In yet another aspect, a method of a content module includes enabling expression of a persona of a user in the content module, associating with the persona specific contacts and groups associated with the user's behaviors, activities, and preferences in the content module and generating a shared page between the user and other user across different ones of the persona with a management module that generates relationships of the user across any number of the content module through the shared page in which each relationship is independent of the persona currently being expressed and which may be common across past, current, and/or future content modules.

Furthermore, the method may include providing a feedback rating through intelligence gathered from personal representation of the user to other users, perception of the other users, behavior analysis of the user and linked other users through a relationship behavior compounding algorithm, and/or collective contact rating of peers.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a management module communicating with a content module through a network, according to one embodiment.

FIG. 2 is an exploded view of the management module of FIG. 1, according to one embodiment.

FIG. 3 is an exploded view of a shared context module of FIG. 1, according to one embodiment.

FIG. 4 is a table view of information associated with the different persona profiles, according to one embodiment.

FIG. 5 is a user interface view of the shared context module of FIG. 1, according to one embodiment.

FIG. 6 is a diagrammatic system view of a data processing system in which any of the embodiments disclosed herein may be performed, according to one embodiment.

FIG. 7 is a user interface view of a profile, according to one embodiment.

FIG. 8 is a user interface view of a shared page, according to one embodiment.

FIG. 9 is a user interface view of a my page, according to one embodiment.

FIG. 10 is a user interface view of a search tool, according to one embodiment.

FIG. 11 is a user interface view of a time zoom, according to one embodiment.

FIG. 12A is a process flow of the shared context module of FIG. 1, according to one embodiment.

FIG. 12B is a continuation of the process flow of FIG. 12A showing additional processes, according to one embodiment.

FIG. 12C is a continuation of the process flow of FIG. 12B showing additional processes, according to one embodiment.

FIG. 13 is a process flow of expressing a persona of a user in the content module and providing the feedback rating to the particular user, according to one embodiment.

Other features of the present embodiments will be apparent from the accompanying drawings and from the detailed description that follows.

### DETAILED DESCRIPTION

A method, system and apparatus of generation of contextual information in communication between parties are disclosed. In the following description, for the purposes of explanation, numerous specific details are set forth in order to provide a thorough understanding of the various embodiments. It will be evident, however to one skilled in the art that the various embodiments may be practiced without these specific details.

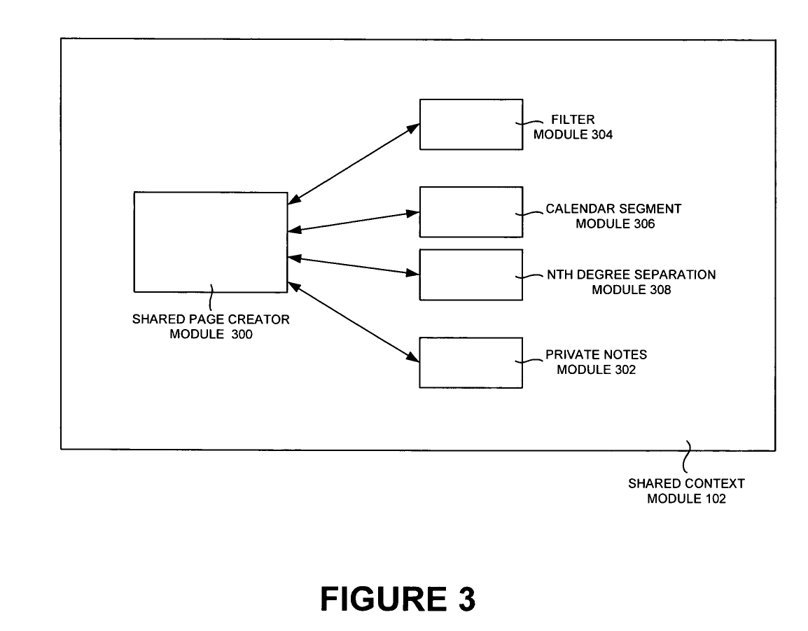

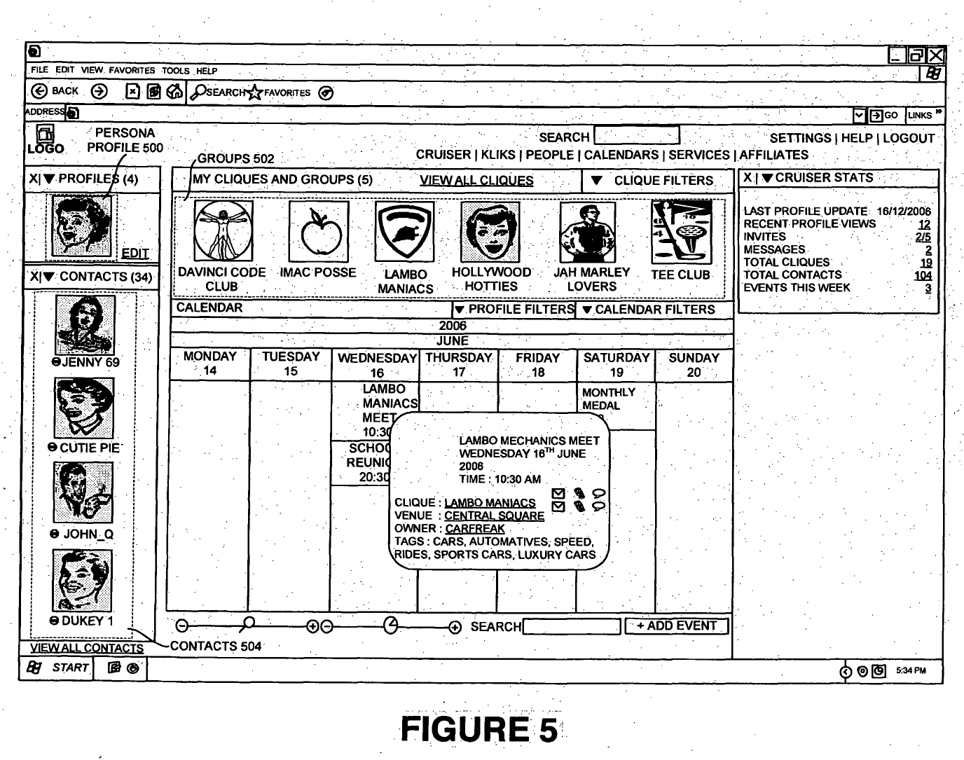

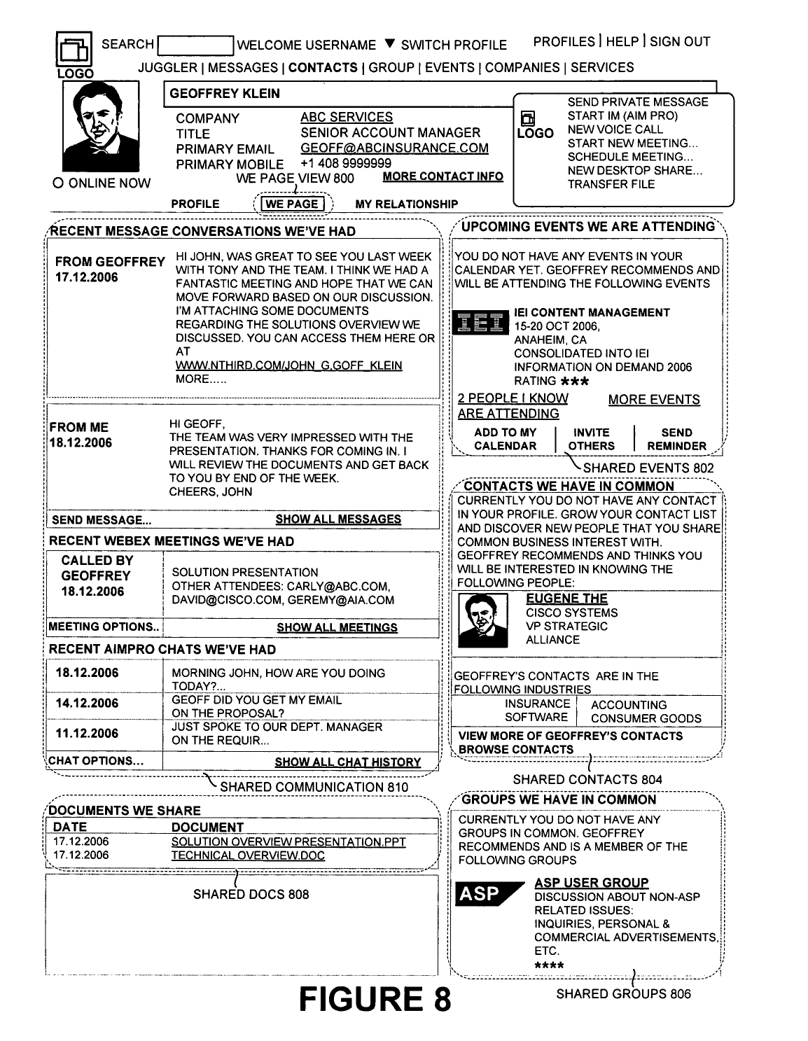

In one embodiment, a method of a communication system includes expressing an interaction between a particular user and other user in a shared page (e.g., we page view 800 of FIG. 8) such that the shared page includes documents, events, and/or communications (e.g., shared events 802, shared docs 808, shared communication 810 of FIG. 8) relevant in communications between the particular user and the other user and generating the shared page (e.g., using the shared page creator 300 of FIG. 3) such that the interaction relevant to a communication between the particular user and the other user are manifested across any number of persona profiles (e.g., the persona profile 500 of FIG. 5) in activities, events, and/or communications associated with in the shared page.

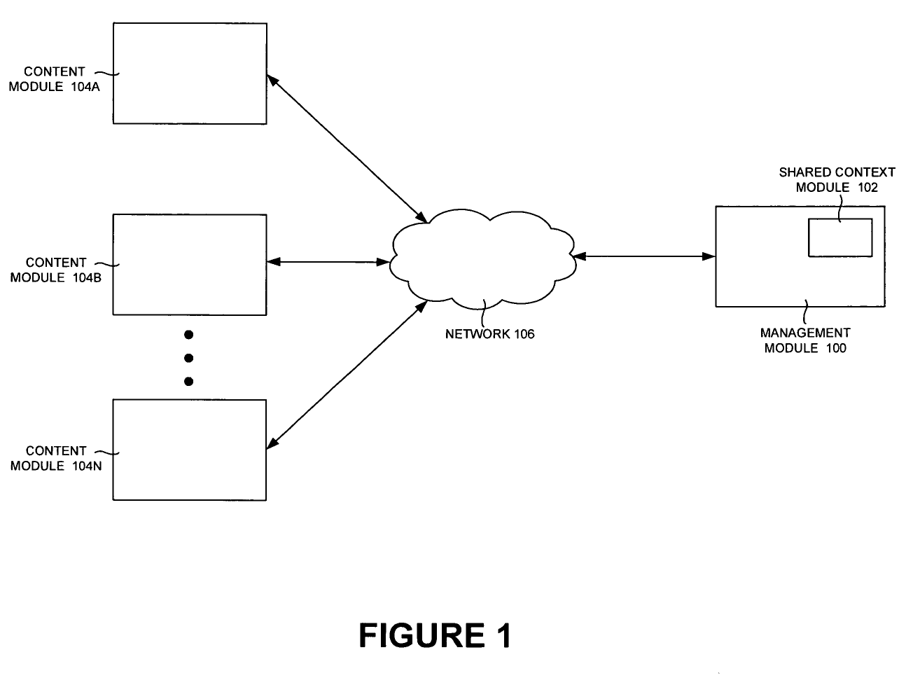

In another embodiment, a communications system includes a network (e.g., the network 106 of FIG. 1), content modules (e.g., the content module 104A-N of FIG. 1) each having an embedded communication module to manage relationships between a user and other users of each the content modules (e.g., the content module 104A-N of FIG. 1) and a shared context module (e.g., the shared context module 102 of FIG. 1) in a management module (e.g., the management module 100 of FIG. 1) to communicate through the network (e.g., the network 106 of FIG. 1) with the content modules (e.g., the content module 104A-N of FIG. 1) and to generate a shared page (e.g., using the shared page creator 300 of FIG. 3) having captured interaction in each of the content modules (e.g., the content module 104A-N of FIG. 1) between a particular user and other user based on a behavior of the particular user associated with each of the content modules (e.g., the content module 104A-N of FIG. 1) with the other user through an analysis of self expressed and/or peer expressed feedback.

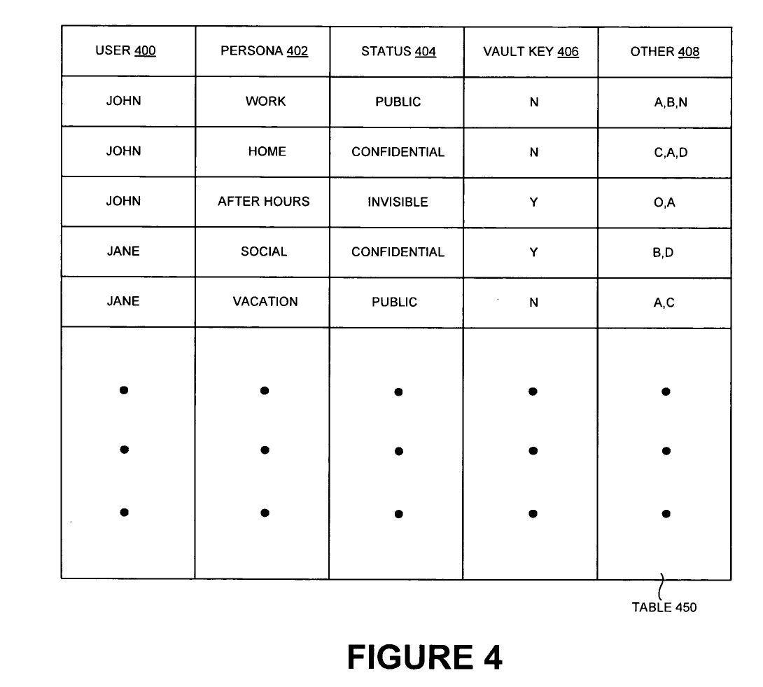

In yet another embodiment, a method of a content module (e.g., the content module 104A-N of FIG. 1) includes enabling expression of a persona of a user (e.g., the persona may be one of the persona illustrated in persona field 402 of FIG. 4) in the content module, associating with the persona specific contacts and/or groups associated with user's behaviors, activities, and/or preferences in the content module (e.g., the content module 104A-N of FIG. 1) and generating a shared page (e.g., using shared page creator 300 of FIG. 3) between the user and other user across different ones of the persona (e.g., the persona 402 of FIG. 4) with a management module (e.g., the management module 100 of FIG. 1) that generates relationships of the user across a plurality of the content module (e.g., the content module 104A-N of FIG. 1 ) through the shared page in which each relationship is independent of the persona currently being expressed and/or which is common across past, current, and/or future content modules.

FIG. 1 is a system view of a management module 100 communicating with a content module 104A-N through a network 106, according to one embodiment. Particularly, FIG. 1 illustrates the management module 100, a shared context module 102, the content module 104A-N and the network 106, according to one embodiment.

The management module 100 may generate and/or classify relationships (e.g., the relationships may be independent of the persona currently generated) of the user from the shared persona across the content modules. The management module 100 may also analyze an intelligence (e.g., the intelligence may be drawn together from the perception of the other user, behavior analysis of the user, personal representation of the user to the others user, etc.) to determine the order of display of a unitary user profile.

The shared context module 102 may generate a shared page to manifest the interaction relevant to the communication between the particular user and the other user across personal profiles in any one of the activities, events, communications, etc. The shared context module 102 may generate the shared page (e.g., that may facilitate the particular user to express interaction in the form of documents, events and/or communication, etc.).

The content modules 104A-N may convert the data to information (e.g., behavior, preferences, and/or activities of the particular user) associated with the particular user of the communication system. The content module 104A-N may contain communication modules that manage relationships between particular user and the other users of the communication system. The network 106 (e.g., internet, LAN, telecommunications network, wireless network, etc.) may be a gateway for efficient communication between the management module 100 and content module 104A-N. In the example embodiment illustrated in FIG. 1, the management module 100 may communicate with the content modules 104A-N through the network 106.

For example, an interaction between a particular user and any one user in the shared page may be expressed such that the shared page includes documents, events, and/or communications (e.g., the shared events 802, the shared docs 808, and the shared communication 810 of FIG. 8) relevant in communications between the particular user and the other user. In addition, the shared page may be generated (e.g., using the shared page creator 300 of FIG. 3) such that the interaction relevant to a communication between the particular user and the other user are manifested across a persona profiles (e.g., the persona profile 500 of FIG. 5) in activities, events, and/or communications associated with in the shared page.

Also, a segmentible calendar (e.g., generated by the calendar segment module 306 of FIG. 3) in the shared page that illustrates visually interaction solely between the particular user and combination of user and/or non-users may be determined. Furthermore, a communications system includes the network 106. The communication system also includes the content modules 104A-N each having an embedded communication module to manage relationships between a user and other users of each of the content modules 104A-N.

The communication system further includes the shared context module 102 in the management module 100 to communicate through the network 106 with the content module 104A-N and/or to generate the shared page having captured interaction in each of the content modules 104A-N between the particular user and other user based on a behavior of the particular user associated with each of the content modules 104A-N with the other user through an analysis of self expressed and/or peer expressed feedback.

In addition, the communications system may also include a vault module in which an invisible communication group may be viewable simultaneously with a confidential communication group and/or a public communication group through a multi-layer authentication technique enabled through the management module 100. Furthermore, expression of a persona (e.g., the persona 402 of FIG. 4) of the user may be enabled in the content module 104A-N. Also, the persona (e.g., the persona 402 of FIG. 4) may be associated with specific contacts and/or groups associated with user's behaviors, activities, and/or preferences in the content module 104A-N.

In addition, the shared page between the user and other user may be generated across different ones of the persona (e.g., the persona 402 of FIG. 4) with the management module 100 that generates relationships of the user across the content module 104A-N through the shared page (e.g., created using the shared page creator 300 of FIG. 3) in which each relationship is independent of the persona currently being expressed and/or which is common across past, current, and/or future content modules.

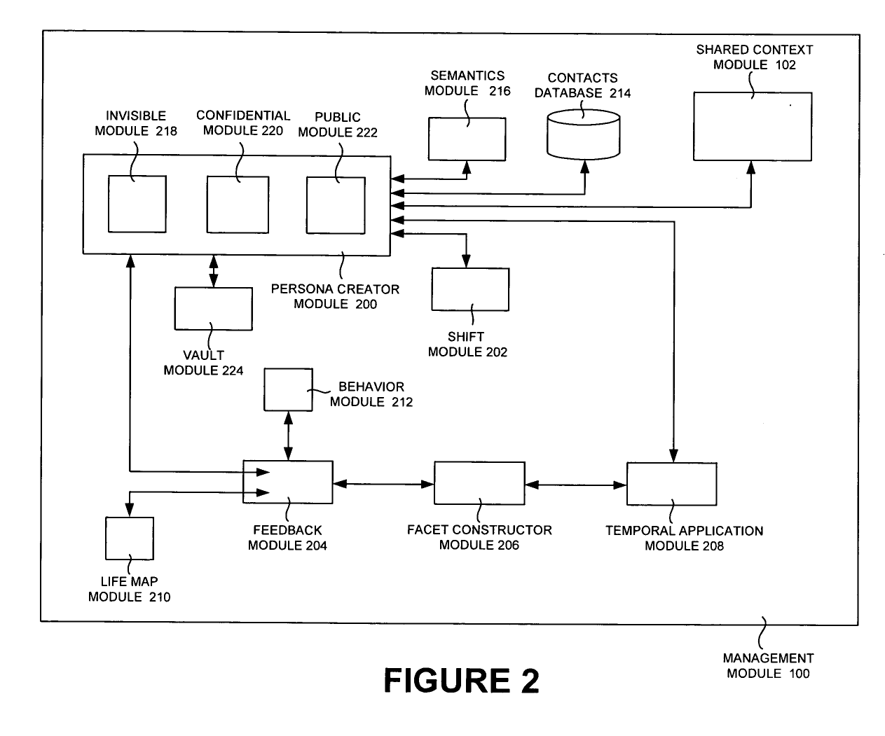

Moreover, a feedback rating through intelligence gathered (e.g., information gathered by the feedback module 204 of FIG. 2) from personal representation of the user to other users, perception of the other users, behavior analysis of the user and linked other users through a relationship behavior compounding algorithm, and/or collective contact rating of peers.

FIG. 2 is an exploded view of the management module 100 of FIG. 1, according to one embodiment. Particularly, FIG. 2 illustrates the shared context module 102, a persona creator module 200, a shift module 202, a feedback module 204, a facet constructor module 206, a temporal application module 208, a life map module 210, a behavior module 212, a contacts database 214, a semantics module 216, an invisible module 218, a confidential module 220, a public module 222, a vault module 224, according to one embodiment.

The persona creator module 200 may contain the invisible module 218, the confidential module 220, and/or the public module 222. The persona creator module 200 may create and/or update a persona profile that may contain contacts of a user in a specific context (e.g., the context may facilitate social interaction of the particular user with the other user) of expression. The shift module 202 may alter between the shared page and the other shared pages without affecting the relationship between the particular user and the other users which may be independent of currently utilized personal profiles.

The feedback module 204 may analyze the intelligence through the relationship behavior compounding algorithm and/or collective contact rating of peers. In addition, the feedback module 204 may determine an order of the display of the unitary user profile. The facet constructor module 206 may be a family relationship constructor, an organization chart constructor, and/or an activity classifier that may enable the particular user to manifest specialized facets (e.g., a family facet, a work facet, a social facet, etc.) in context of a particular scenario of communications.

The temporal application module 208 may apply a temporal aspect to each of the facet through the facet constructor module 206 based on a propensity that may be user determined and/or automatically determined through a usage pattern mapping. Similarly, the temporal application module 208 may apply temporal aspects to each of the facets to enable a time based priority ranking of the particular contact with the other contacts.

The life map module 210 may generate life maps of the user in which the differing activities and/or behaviors of the user may be expressed in an electronic environment. The behavior module 212 may carry out the behavior analysis of the user and/or linked other users to provide intelligence information (e.g., data and/or meta-data) to the feedback module 204. The contacts database 214 may contain information associated with the contact details of the user of the communication system. The semantics module 216 may organize the specific contacts introduced by <person/entity>, met at <show name>, works at <company name>, and/or interest include <interest name>.

The invisible module 218 may allow the user to access the invisible persona profile when a proper vault key is applied. Also, the invisible module 218 may enable an invisible relationship in the invisible persona profile and/or invisible contacts and/or invisible groups on application of the proper vault key by the user of the communication system.

The confidential module 220 may generate the confidential persona profile that may include relationships with groups in which communication between the user and other users are restricted to specific groups of trusted users who have a contextual relationship with the user. The public module 222 may create a public profile that may include relationships that may be sharable with any known and/or unknown parties in the communications system. The vault module 224 may enable the user to view the invisible communication profile simultaneously with the confidential communication profile and public communication profile through a tiered authentication technique. The vault module 224 may facilitate the user to access the invisible communication profile in the visible mode when user applies a correct vault key.

In example embodiment illustrated in FIG. 2, the persona creator module 200 may communicate with the shift module 202, the feedback module 204, the temporal application module 208, the contacts database 214, and/or the semantics module 216. Also, the persona creator module 200 may interact with the shared context module 102 of FIG. 1 as illustrated in the example embodiment of FIG. 2. Furthermore, the feedback module 204 may communicate with the facet constructor module 206, the life map module 210, the behavior module 212. The facet constructor module 206 as illustrated in example embodiment of FIG. 2 may also communicate with the temporal application module 208.

For example, the shared page may be generated (e.g., shared page may be generated using the shared context module 102 of FIG. 1) such that the interaction relevant to the communication between the particular user and the other user are manifested across any number of persona profiles (e.g., the persona profile 500 of FIG. 5) in activities, events, and/or communications associated with in the shared page. A preferred ranking of specific documents, events, and/or communications (e.g., the shared events 802, the shared docs 808, and shared communication 810 of FIG. 8) relevant in communications between the particular user and other user, may be organized based on a behavior of the particular user and/or the feedback rating provided of the particular user by other parties (e.g., through feedback module 204 of FIG. 2).

In addition, a digest of relevant sections of the specific communications may be generated such that the relevant sections capture a critical message of communication between the particular user and other user including a subject-line less message and/or a last paragraph text.

Furthermore, the shared page may be alternated with other shared pages (e.g., using the shift module 202 of FIG. 2) while maintaining the relationship between the particular user and other user which is independent of any one of the persona profiles (e.g., persona profile 500 of FIG. 5) currently utilized. The facets may be enabled through the feedback ratings that are created through implicit and/or explicit techniques based on trust, affinity, and/or propensity of interaction and/or in which multiple facets coexist in each persona profile and/or which develop a set of rankings of the particular user with the other users through each of the facets.

Also, a life map may be generated (e.g., using a life map module 210 of FIG. 2) in the shared page of the particular user and/or other user in which differing activities and/or behaviors of the particular user are simultaneously expressed in the shared page. Similarly, the life map may be organized around a common marker selected between people communications, events, groups, places, messages, money, and/or content including music, books, and/or news feeds.

Furthermore, the communications system may include the feedback module 204 of the management module 100 of FIG. 1 to analyze intelligence gathered from personal representation of the particular user to other users, perception of the other users, behavior analysis of the user and linked other users through the relationship behavior compounding algorithm, and/or collective contact rating of peers to determine an order of display of the unitary user profile in the management module 100 of FIG. 1 of each of groups in the embedded communication module.

FIG. 3 is an exploded view of the shared context module 102 of FIG. 1, according to one embodiment. Particularly, FIG. 3 illustrates the shared page creator 300, a private notes module 302, a filter module 304, a calendar segment module 306 and a nth degree separation module 308, according to one embodiment.

The shared page creator 300 may generate shared pages that contain the communications, documents and/or events relevant to communications between the particular user and other users of the communication system. In addition, the shared page creator 300 may customize the shared page based on the relationship modality of the particular user with the other users, based on the specialized facet determined, based on the behavior and/or association of the particular user including the family. The private notes module 302 may generate a set of private notes of the particular user about the other user associated and/or linked with shared page.

The filter module 304 may categorize the shared page generated by the shared page creator 300 based on a temporal criteria specified by the particular user. The calendar segment module 306 may determine the segmentible calendar in the shared page that may illustrate (e.g., visually) interaction solely between the particular user and combination of other user and/or non-users. The nth degree separation module 308 may embed any groups and/or users common to the particular user and/or the other user through nth degree separations (e.g., levels of abstraction of association, degrees of interpersonal relevance) in the shared paged created by the shared page creator 300.

In the example embodiment illustrated in FIG. 1, the shared page creator 300 may communicate with the private notes module 302, the filter module 304, the calendar segment module 306, and the nth degree separation module 308.

For example, the shared page may be generated (e.g., through shared page creator 300 of FIG. 3) such that the interaction relevant to the communication between the particular user and the other user are manifested across any number of persona profiles (e.g., the persona profile 500 of FIG. 5) in activities, events, and/or communications associated with in the shared page (e.g., as illustrated in a user interface view of FIG. 8). Also, any groups and/or users common to the particular user and the other user may be embedded through the nth-degree separation in the shared page (e.g., using nth degree separation module 308 of FIG. 3), and/or displaying the relationship simultaneously in the shared page.

The set of private notes of the particular user (e.g., the private notes may be generated by the private notes module 302 of FIG. 3) about the user may be generated in a relationships annotation module associated and/or linked with the shared page. In addition, the shared page may be filterable (e.g., using the filter module 304 of FIG. 3) based on a temporal criteria specified by the particular user across granularities, time zones, and/or daily routines.

Furthermore, the shared page may be generated between the user and other user across different ones of the persona (e.g., the persona 402 of FIG. 4) with the management module (e.g., the management module 100 of FIG. 1) that generates relationships of the user across the content module (e.g., the content module 104A-N of FIG. 1) through the shared page in which each relationship is independent of the persona currently being expressed (e.g., the different persona illustrated in persona field 402 of FIG. 4) and/or which is common across past, current, and/or future content modules.

FIG. 4 is a table view of information associated with the different persona profiles, according to one embodiment. Particularly, FIG. 4 illustrates a user field 400, a persona field 402, a status field 404, a vault key field 406, and an other field 408, according to one embodiment.

The table 450 of FIG. 4 illustrates information associated with the different persona profiles (e.g., name of the user, persona, status of the persona profile, a vault key status, etc.). The user field 400 may display names of the user associated with the particular persona profile. The persona field 402 may display different contexts of communication that may be taking place between the particular user and other parties. The Status field 404 may display information associated with the status of the persona profile of the particular user.

The vault key field 406 may display whether the particular user has access to the vault keys (e.g., the vault key may enable the user to access the invisible persona profile.). The other field 408 may display other information associated with the user (e.g., feedback rating of the user, contacts list, events, company name, etc.).

In example embodiment illustrated in FIG. 4, the user field 400 displays “JOHN” in the first row, “JOHN” in the second row, “JOHN” in the third row, “JANE” in the fourth row, and “JANE” in the fifth row of the user field 400 column of the table 450. The persona field 402 as illustrated in example embodiment of FIG. 4 displays “WORK” in the first row, “HOME” in the second row, “AFTER HOURS” in the third row, “SOCIAL” in the fourth row, and “VACATION” in the fifth row of the persona 402 column of the table 450.

The status field 404 displays “PUBLIC” in the first row, “CONFIDENTIAL” in the second row, “INVISIBLE” in the third row, “CONFIDENTIAL” in the fourth row, and “PUBLIC” in the fifth row of the status field 404 column of the table 450. The vault key field 406 displays “N” in the first row, “N” in the second row, “Y” in the third row, “Y” in the fourth row, “N” in the fifth row of the vault key field 406 column of the table 450 of FIG. 4.

In the example embodiment illustrated in FIG. 4, the other field 408 displays “A, B, N” in the first row, “C, A, D” in the second row, “O, A” in the third row, “B, D” in the fourth row, and “A, C” in the fifth row of the other field 408 column of the table 450 of FIG. 4.

FIG. 5 is a user interface view of the shared context module of FIG. 1, according to one embodiment. Particularly, FIG. 5 illustrates the persona profile 500, groups 502 and contacts 504, according to one embodiment. The persona profile 500 may comprise the contacts of the user in a specific context of expression sharing the identity of the user in which a context is provided to each social interaction of the particular user with other users.

The groups 502 may display communications between the particular user and other users (e.g., restricted to specific trusted users who may have a contextual relationship with the user). For example, the public profile displayed in the groups 502 view may include relationships shared with known and/or unknown parties in the communications system. The contacts 504 may be the specific contacts and/or groups associated with the user's behaviors, activities, and/or preferences in the communication system.

In example embodiment illustrated in FIG. 5, the user associated with the communication system may view the persona profile 500 of a particular user profile (e.g., displaying the particular user's contacts, image and/or profile).

The contacts 504 may consist of profiles of other users (e.g., friends, partners, relatives, etc.) related to the particular user profile, and/or displaying their images, profile, contacts, etc. The groups 502 may include groups (e.g., groups may be based on behaviors, activities, preferences, favorite clubs, personality, organization, etc.) associated with the particular user (e.g., may be restricted to specific trusted users having a contextual relationship with the user). For example it may contain images and/or profile of the particular user and or the other user relevant to the particular group which the particular user is linked with.

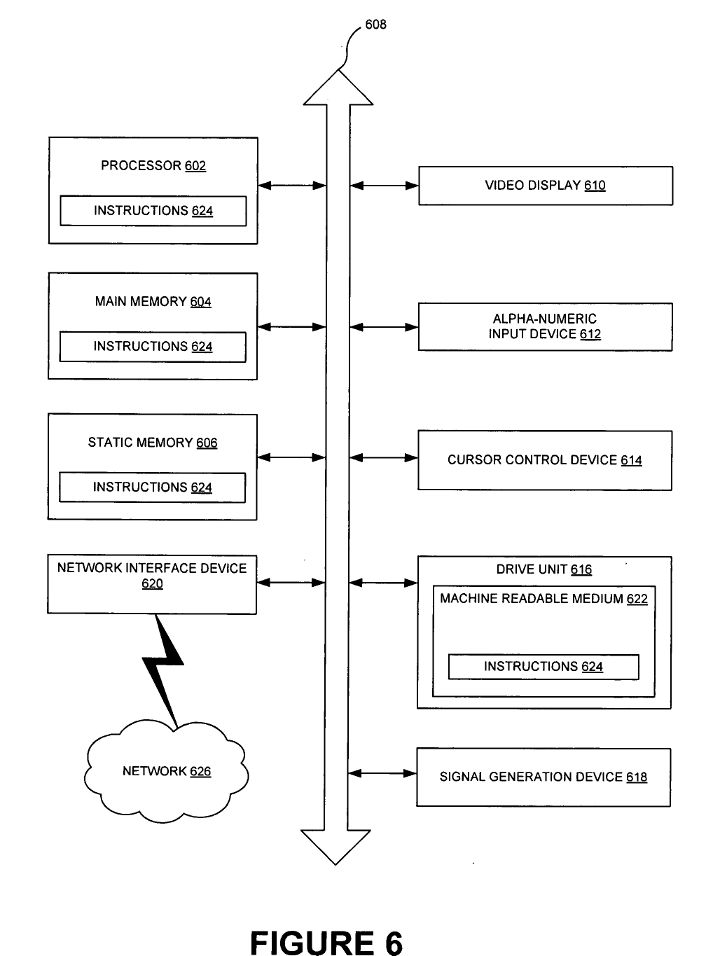

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse.

The drive unit 616 may be the hard drive, a storage system, and/or other longer term storage subsystem. The signal generation device 618 may be a bios and/or a functional operating system of the data processing system. The network interface device 620 may be a device that may perform interface functions such as code conversion, protocol conversion and/or buffering required for communication to and from the network 626. The machine readable medium 622 may provide instructions on which any of the methods disclosed herein may be performed. The instructions 624 may provide source code and/or data code to the processor 602 to enable any one/or more operations disclosed herein.

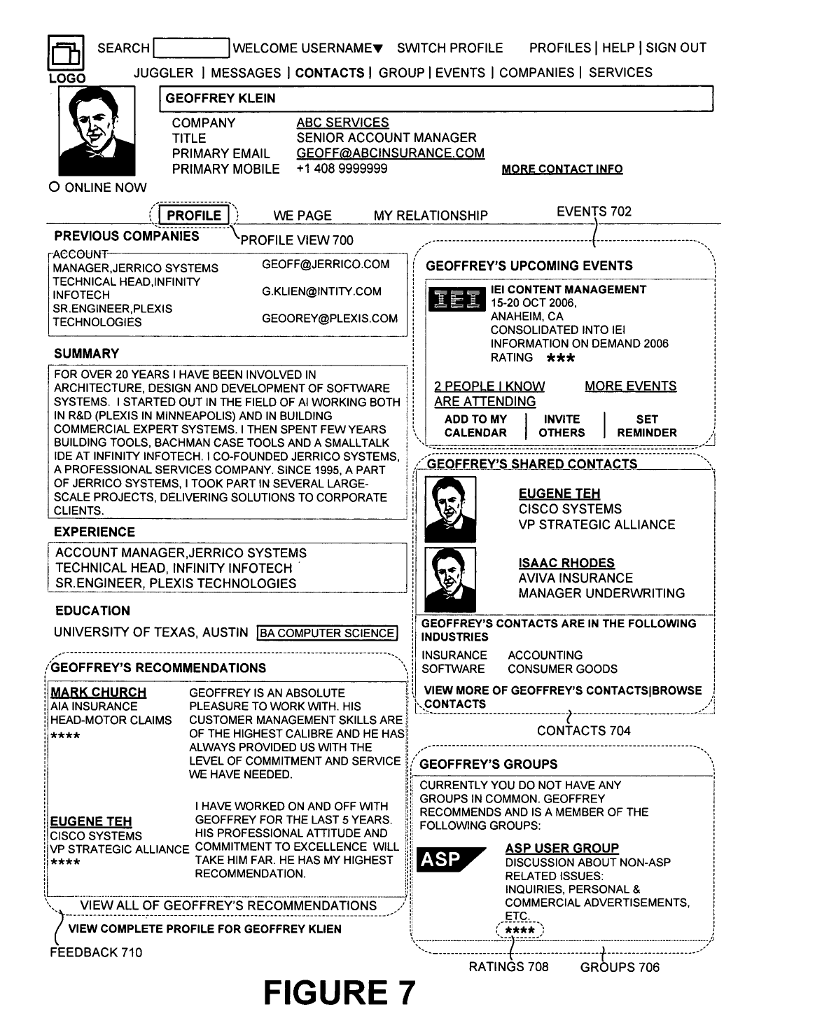

FIG. 7 is a user interface view of a profile, according to one embodiment. Particularly, FIG. 7 illustrates the profile view 700, events 702, contacts 704, groups 706, ratings 708 and a feedback 710, according to one embodiment.

The profile view 700 may display profile information of the particular user in the communication system. The profile view 700 may display information such as names of previous companies, a summary of work experience, designations in the previous companies, educational details of the user, contact details, etc. The events 702 may display upcoming events uploaded by the particular user that may be events of interest. The contacts 704 may facilitate the user of the communication system to view the information associated with the shared contacts of the particular user.

The contacts 704 may also enable the user to view organization types in which the particular user may have contacts. The groups 706 may display the group(s) in which the particular user may have joined as a member. In addition, the groups 706 may display status information associated with the group of the particular user. The rating 708 may enable the user to view the rating of each individual group associated with the particular user. The feedback 710 may display recommendations made by the other users (e.g., shared contacts) and/or may also display feedback ratings (e.g., calculated through the behavior analysis of the user and/or linked other users, perception of other users and/or personal representation of the user to other users).

In the example embodiment illustrated in FIG. 7, the profile view 700 displays profile information for “Geoffrey Klein,” that may contain details of the previous companies where Geoffrey Klein used to work, the summary of the work experience, Geoffrey's designation(s) in the previous companies, educational details of Geoffrey, email ID, contact details for Geoffrey etc. The events 702 view as illustrated in the example embodiment of FIG. 7 displays Geoffrey's upcoming events (e.g., that he is interested in). For example, Geoffrey may be interested in an “IEI content management” event which is illustrated as being scheduled on 15-20 Oct. 2006 at Anaheim, Calif.

In the example embodiment illustrated in FIG. 7 the contacts 704 displays the information associated with Geoffrey's shared contacts and/or displays the industries in which Geoffrey may have contacts. For example Geoffrey may have contacts in Insurance, Accounting, Automotive, Finance, Software, Consumer goods, and/or CRM industries. The groups 706 as illustrated in example embodiment of FIG. 7 displays the recommended groups of which Geoffrey is the member.

The ratings 708 may display the ratings provided for each group in which Geoffrey is the member. In the example embodiment illustrated in FIG. 7, the feedback 710 displays Geoffrey's recommendations created by “Mark Church” and “Eugene “Teh” who may know Geoffrey through different contexts of communication. The feedback 710 view also displays the organizations, designations and ratings associated with Mark Church and Eugene Teh.

For example, a faceted and/or fragmented identity of the particular user may be expressed through each of the persona profiles (e.g., as illustrated in FIG. 5) in which a context is provided to each social interaction of the particular user with the other user.

FIG. 8 is a user interface view of a shared page, according to one embodiment. Particularly, FIG. 8 illustrates a we page view 800, shared events 802, shared contacts 804, shared groups 806, shared docs 808 and a shared communication 810, according to one embodiment. The we page view 800 may provide the user information associated with communications between the users of the communication system, upcoming events, common groups and/or contacts. The shared events 802 may provide information associated with the upcoming events to the particular user of the communication system. The user may be provided with information like time, date, venue, number of people attending and/or ratings of the event.

The shared contacts 804 may display contacts of the users having common interests and/or may also provide information associated with other users. The shared groups 806 may display groups having common interests and/or may also provide information associated with other groups. The shared docs 808 may enable the user of the communication system to manage documents shared among the other users. The shared communication 810 may enable the user to communicate with other users associated with the communication system. For example Geoffrey may send/receive messages to/from John, who may be a shared user of the shared page.

For example, the interaction may be expressed between the particular user and other user in the shared page such that the shared page includes documents, events, and/or communications (e.g., the shared events 802, the shared docs 808, and the shared communication 810 of FIG. 8) relevant in communications between the particular user and the other user. Also, the faceted and/or fragmented identity of the particular user may be expressed through each of the persona profiles in which the context is provided to each social interaction of the particular user with the other user.

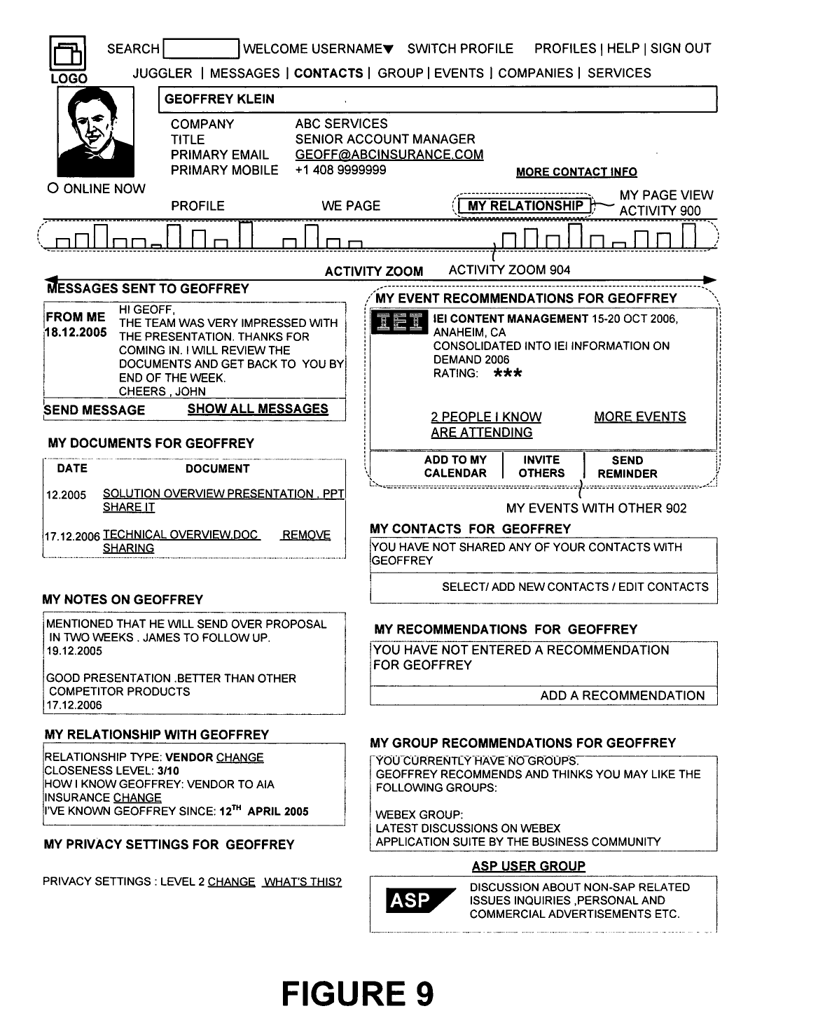

FIG. 9 is a user interface view of a my page, according to one embodiment. Particularly, FIG. 9 illustrates a my page view 900, a my events with other view 902 and an activity zoom 904, according to one embodiment. The my page view 900 may provide the user with information related to events, messages, documents, notes, relations, privacy settings, contacts, and/or recommendations (e.g., from/by other users). The activity zoom 904 may enable the user to view plans of activities (e.g., events, scheduled in a graph format). The my events with other view 902 may provide the particular user with information associated with the events and/or schedules (e.g., time, date, venue, number of people attending and/or the rating of the event).

In the example embodiment illustrated in FIG. 9, users may provide the particular user with information associated with the events. For example, the event may be recommended to the user (e.g., “Geoffrey”). For example, the recommendation may indicate that the event is by “IEI content management,” as illustrated to be scheduled on “15-20 October” in “Anaheim, Calif., and being “consolidated into IEI Information on demand 2006,” and/or two people may be attending the event. The event may be also rated depending on the interests of the user and/or the strength of the recommendation (e.g., by another user). For example, a different persona profile may be expressed based on individual relationship semantics. For example, the faceted and/or fragmented identity of the particular user may be expressed through each of the persona profiles in which the context is provided to each social interaction of the particular user with the other user.

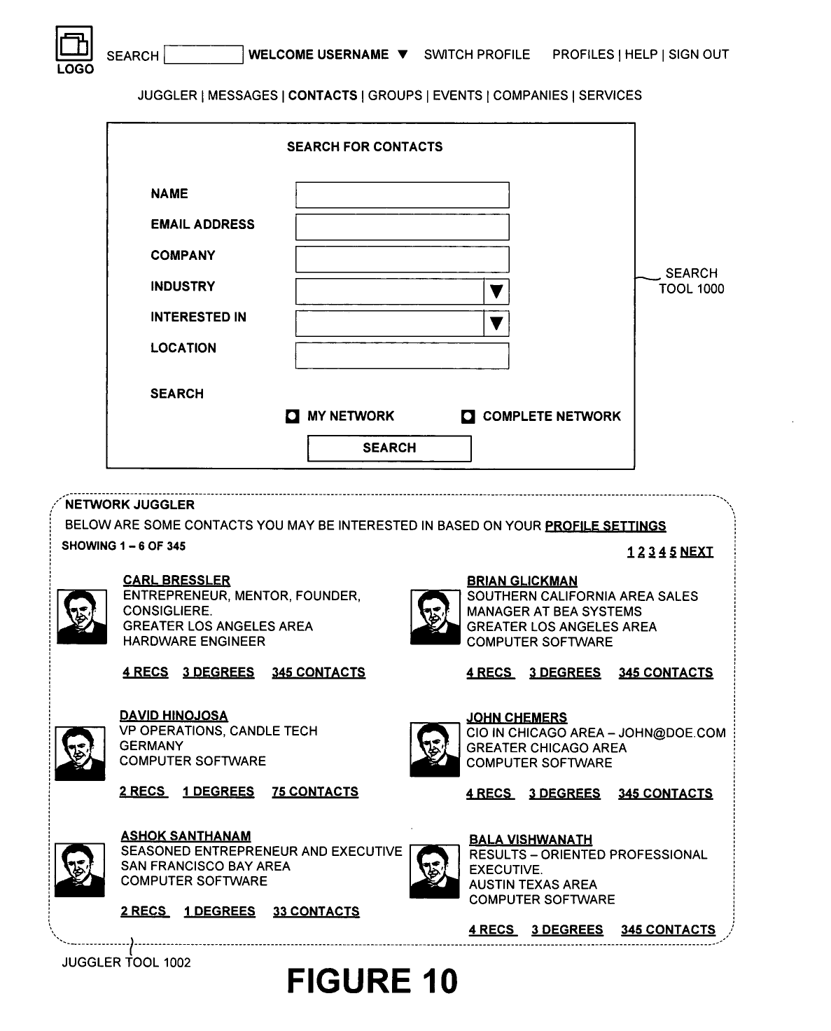

FIG. 10 is a user interface view of a search tool 1000, according to one embodiment. Particularly, FIG. 10 illustrates a search tool 1000 and a juggler tool 1002, according to one embodiment. The search tool 1000 may enable the user of the communication system to conduct a search for other user by providing details (e.g., by the user's interests based on the profile settings). The juggler tool 1002 may organize and/or display contacts (e.g., using semantics) including contacts obtained based on search results.

In the example embodiment illustrated in FIG. 10, the communication system may provide the user with the search tool 1000. The user may conduct a search for other users by providing their information in the name, email address, company, industry, interested in and/or location blocks of the search tool 1000. The search in the communication system may be conducted in the network of the user and/or in the complete (e.g., larger) network by selecting the “my network” and/or “complete network” options.

The search result and/or the information related to the searched contacts may be displayed in the juggler tool. For example the photos, names, addresses, professions, etc of the other users may be displayed in the juggler tool 1002 of the communication system.

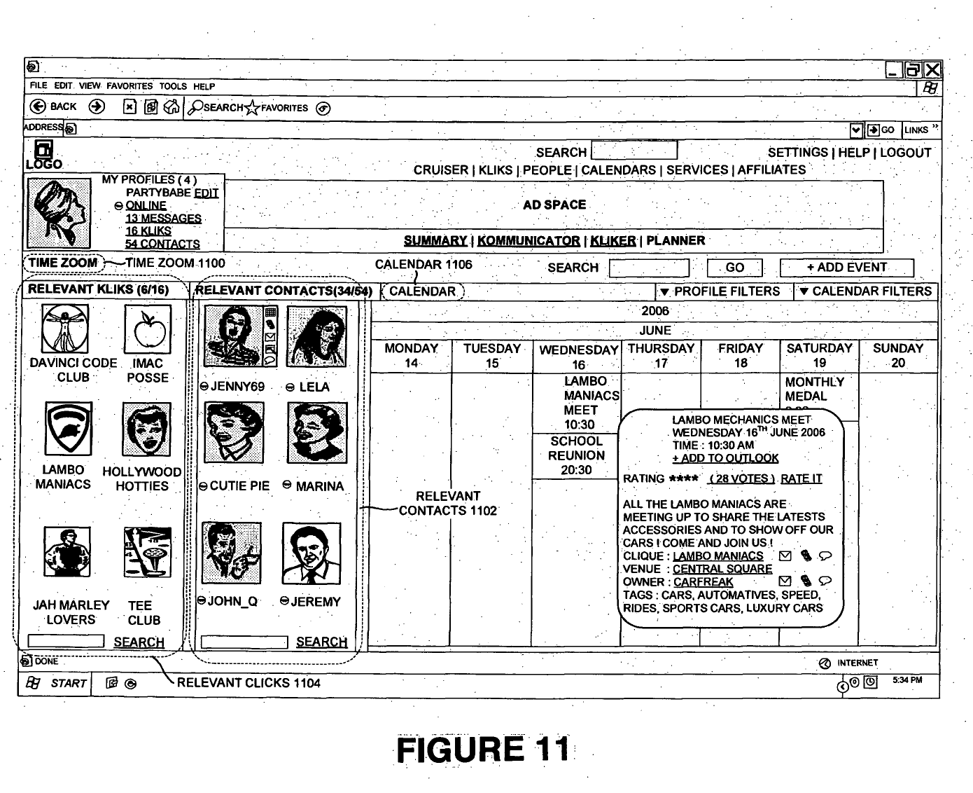

FIG. 11 is a user interface view of a time zoom 1100, according to one embodiment. Particularly, FIG. 11 illustrates the time zoom 1100, relevant contacts 1102, relevant clicks 1104 and a calendar 1106, according to one embodiment. The time zoom 1100 may enable the time based priority ranking of a particular contact (e.g., of the particular user) with other contacts in the communication system. For example, the particular user may track the level of involvement with other users at a particular instant in time.

The relevant contacts 1102 may display the contacts (e.g., profiles) of other users in sections associated with the particular user in the communication system. The relevant contacts 1102 may enable the particular user to communicate with any other user from the list by selecting the profile of the other user in the communication system. The relevant clicks 1104 may display the groups (e.g., groups may be based on associations such as particular behavioral traits, activities, preferences, favorite clubs, personalities, organizational affiliations, etc) in sections associated with the particular user in the communication system. The relevant contacts 1102 may enable the particular user to select any groups from the list in the communication system for any interaction with the other users in the group. The calendar 1106 may enable the user to trace and/or keep a track of schedule of events of importance and/or interest to the particular user.

In the example embodiment illustrated in FIG. 11, the user associated with the communication system may trace the level of involvement with other users at a particular instant in time, in the time zoom 1100. The relevant contacts 1102 may provide information related to other users associated with the user. For example, the relevant contacts 1102 may provide information about the other users (e.g., photos, profiles, names, contact information, interests of the users and/or status (e.g., online, busy, idle, offline, etc) of the users). The relevant contacts 1102 may contain a search window to effectively search for other users' profiles, images etc. The relevant clicks 1104 may provide information about the groups associated with the particular user and/or search tools to search for other group profiles, images etc. The calendar 1106 may provide the user with a calendar that displays the year, month, day and/or time in which the user may feed the events of interest and/or importance (e.g., meeting, functions, birthday, etc) for further reference.

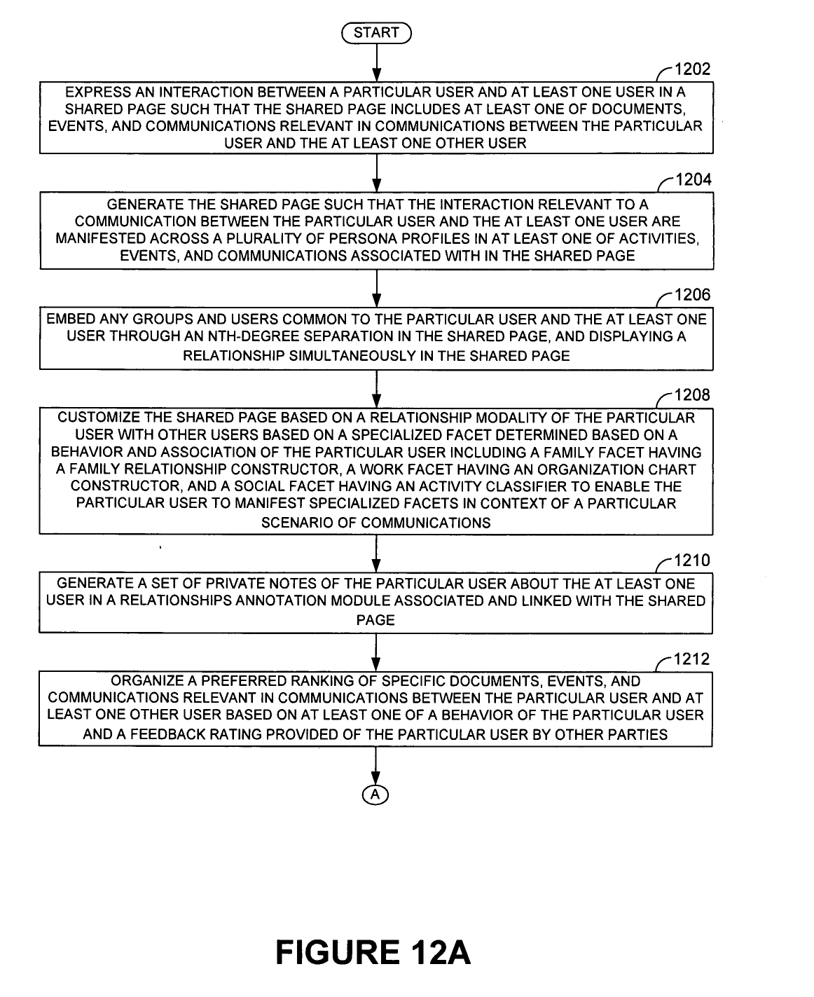

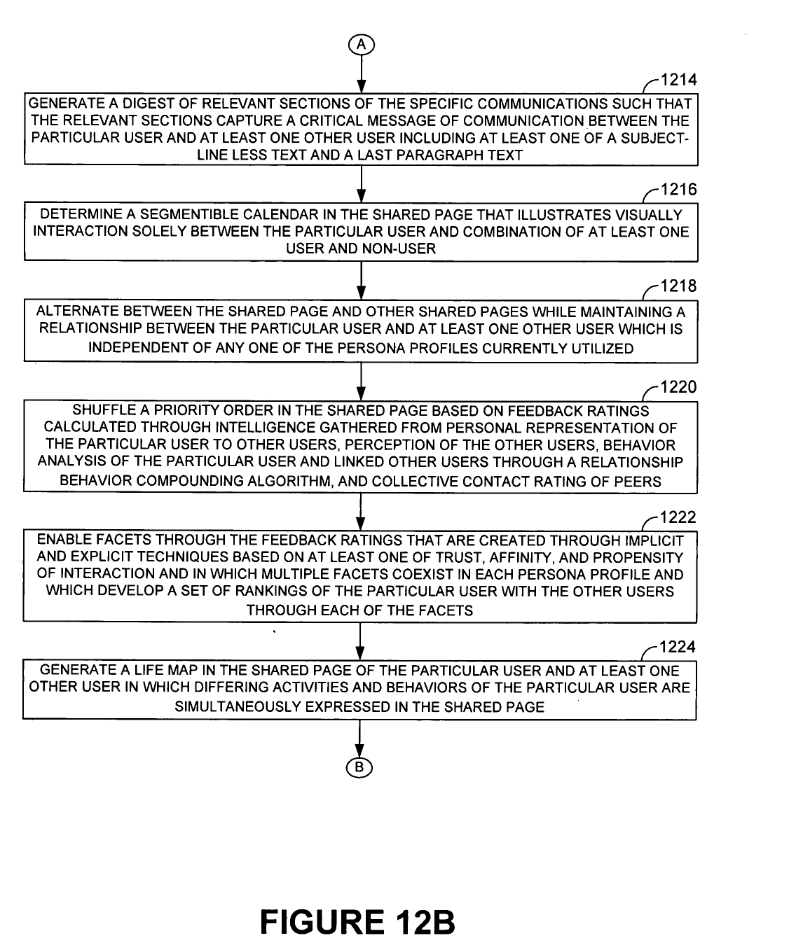

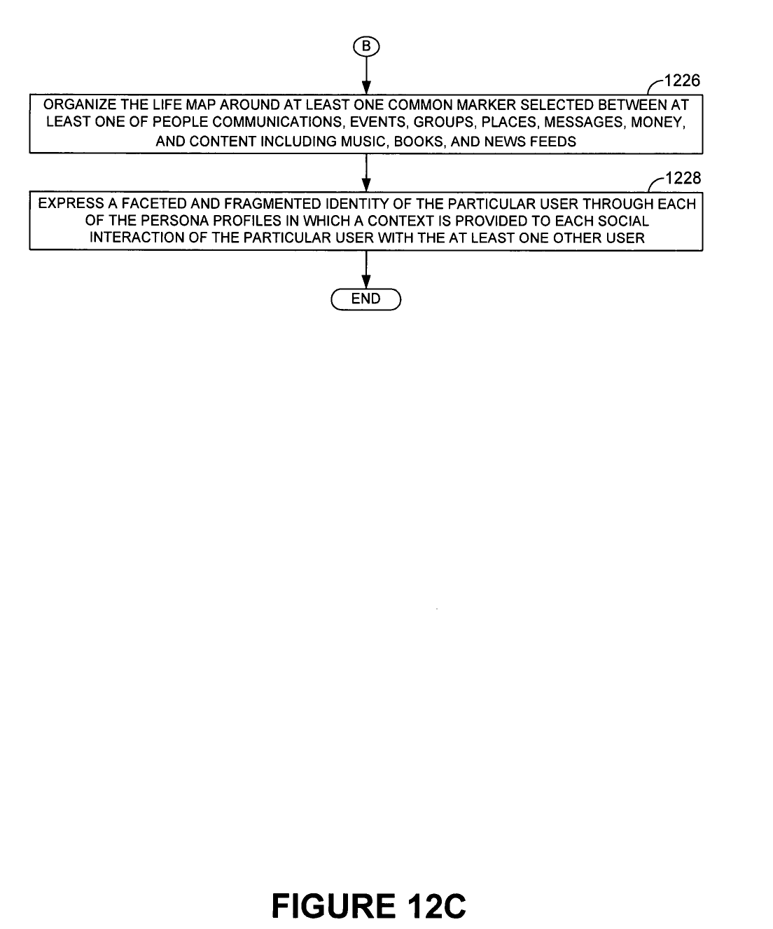

FIG. 12A is a process flow of the shared context module 102 of FIG. 1, according to one embodiment. In operation 1202, an interaction between a particular user (e.g., the user 400 of FIG. 4) and at least one user (e.g., the user 400 of FIG. 4) in a shared page may be expressed such that the shared page (e.g., the shared page may be generated using the shared page creator 300 of FIG. 3) includes at least one of documents, events, and communications (e.g., the shared events 802, the shared docs 808, and the shared communications 810 of FIG. 8) relevant in communications between the particular user (e.g., the user 400 of FIG. 4) and the at least one other user. In operation 1204, the shared page may be generated (e.g., the shared page may be generated using the shared page creator 300 of FIG. 3) such that the interaction relevant to a communication between the particular user (e.g., the user 400 of FIG. 4) and the at least one user (e.g., the user 400 of FIG. 4) are manifested across a plurality of persona profiles (e.g., the persona profile 500 of FIG. 5) in at least one of activities, events, and communications associated with in the shared page.

In operation 1206, any groups and users common to the particular user (e.g., the user 400 of FIG. 4) and the at least one user (e.g., the user 400 of FIG. 4) may be embedded through an nth-degree separation in the shared page (e.g., using a nth degree separation module 308 of FIG. 3), and displaying a relationship simultaneously in the shared page. In operation 1208, the shared page may be customized based on a relationship modality of the particular user (e.g., the user 400 of FIG. 4) with other users based on a specialized facet determined based on a behavior and association of the particular user (e.g., the user 400 of FIG. 4) including a family facet having a family relationship constructor, a work facet having an organization chart constructor, and a social facet having an activity classifier to enable the particular user (e.g., the user 400 of FIG. 4) to manifest specialized facets (e.g., through facet constructor module 206 of FIG. 2) in context of a particular scenario of communications.

In operation 1210, a set of private notes of the particular user about the at least one user may be generated (e.g., using the private notes module 302 of FIG. 3) in a relationships annotation module associated and linked with the shared page. In operation 1212, a preferred ranking of specific documents, events, and communications relevant in communications between the particular user and at least one other user may be organized based on at least one of a behavior of the particular user (e.g., the user 400 of FIG. 4) and a feedback rating provided of the particular user by other parties.

FIG. 12B is a continuation process flow of FIG. 12A, according to one embodiment. In operation 1214, a digest of relevant sections of specific communications may be generated such that the relevant sections capture a critical message of communication between the particular user (e.g., the user 400 of FIG. 4) and at least one other user including at least one of a subject-line less message and a last paragraph text.

In operation 1216, a segmentible calendar may be determined (e.g., using a calendar segment module 306 of FIG. 3) in the shared page that illustrates visually interaction solely between the particular user (e.g., the user 400 of FIG. 4) and combination of at least one user and non-user. In operation 1218, the shared page and other shared pages may be altered while maintaining a relationship between the particular user and at least one other user which is independent of any one of the persona profiles currently utilized.

In operation 1220, a priority order in the shared page may be shuffled based on feedback ratings calculated through intelligence gathered from personal representation of the particular user (e.g., the user 400 of FIG. 4) to other users, perception of the other users, behavior analysis of the particular user (e.g., the user 400 of FIG. 4) and linked other users through a relationship behavior compounding algorithm, and collective contact rating of peers.

In operation 1222, facets may be enabled through the feedback ratings that are created through implicit and explicit techniques based on at least one of trust, affinity, and propensity of interaction and in which multiple facets coexist in each persona profile and which develop a set of rankings of the particular user (e.g., the user 400 of FIG. 4) with the other users through each of the facets. In operation 1224, a life map may be generated (e.g., using the life map module 210 of FIG. 2) in the shared page of the particular user and at least one other user in which differing activities and behaviors of the particular user (e.g., the user 400 of FIG. 4) are simultaneously expressed in the shared page.

FIG. 12C is a continuation process flow of FIG. 12B, according to one embodiment. In operation 1226, the life map may be organized around at least one common marker selected between at least one of people communications, events, groups, places, messages, money, and content including music, books, and news feeds. In operation 1228, a faceted and fragmented identity of the particular user (e.g., the user 400 of FIG. 4) may be expressed through each of the persona profiles in which a context is provided to each social interaction of the particular user (e.g., the user 400 of FIG. 4) with the at least one other user.

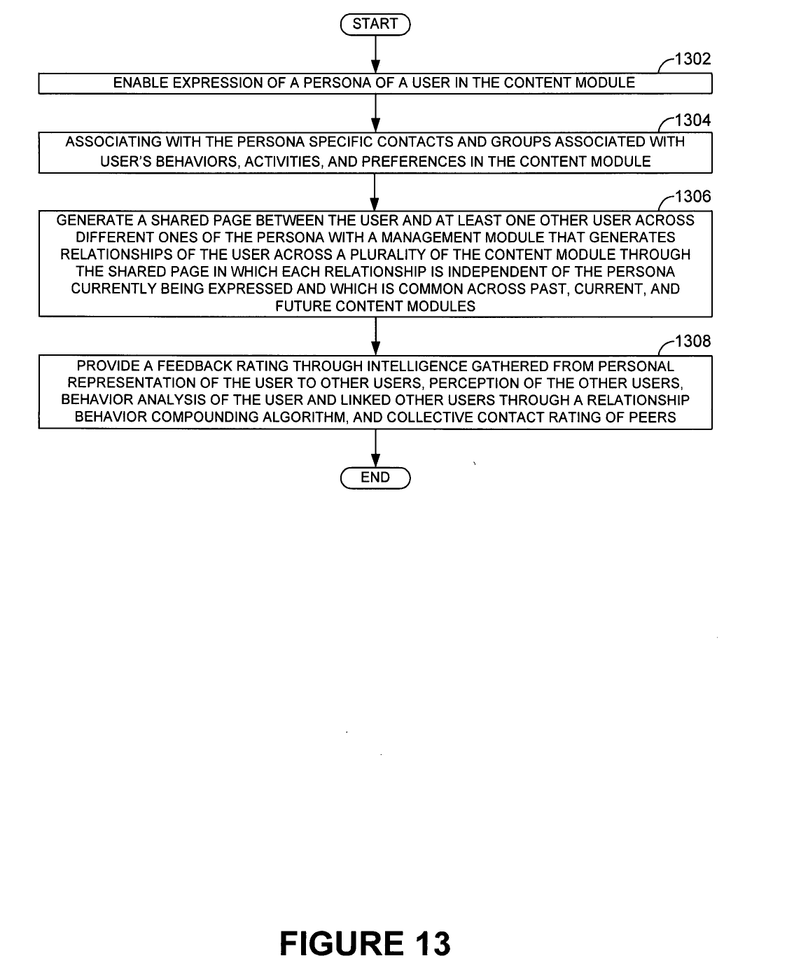

FIG. 13 is a process flow of expressing a persona of a user in the content module and providing the feedback rating to the particular user, according to one embodiment. In operation 1302, expression of a persona (e.g., the persona 402 of FIG. 4) of a user (e.g., the user 400 of FIG. 4) may be enabled in a content module (e.g., the content module 104A-N of FIG. 1). In operation 1304, persona (e.g., the persona 402 of FIG. 4) specific contacts and groups may be associated with user's (e.g., the user 400 of FIG. 4) behaviors, activities, and preferences in the content module (e.g., the content module 104A-N of FIG. 1).

In operation 1306, a shared page may be generated between the user (e.g., the user 400 of FIG. 4) and at least one other user across different ones of the persona (e.g., the persona 402 of FIG. 4) with a management module (e.g., the management module 100 of FIG. 1, the management module 100 of FIG. 2) that generates relationships of the user (e.g., the user 400 of FIG. 4) across a plurality of the content module (e.g., the content module 104A-N of FIG. 1) through the shared page in which each relationship is independent of the persona (e.g., the persona 402 of FIG. 4) currently being expressed and which is common across past, current, and future content modules (e.g., the content module 104A-N of FIG. 1).

In operation 1308, a feedback rating may be provided through intelligence gathered from personal representation of the user (e.g., the user 400 of FIG. 4) to other users, perception of the other users, behavior analysis of the user (e.g., the user 400 of FIG. 4) and linked other users through a relationship behavior compounding algorithm, and collective contact rating of peers.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example the management module 100, the shared context module 102, the content module 104A-N, the persona creator module 200, the shift module 202, the feedback module 204, the facet constructor module 206, the temporal application module 208, the life map module 210, the behavior module 212, the semantics module 216, the invisible module 218, the confidential module 220, the public module 222, the vault module 224, the private notes module 302, the filter module 304, the calendar segment module 306, the nth degree separation module 308, and other modules of FIGS. 1-3 may be embodied through the management circuit, the shared context circuit, the content circuit, the persona creator circuit, the shift circuit, the feedback circuit, the facet constructor circuit, the temporal application circuit, the life map circuit, the behavior circuit, the semantics circuit, the invisible circuit, the confidential circuit, the public circuit, the private notes circuit, the filter circuit, the calendar segment circuit, the nth degree separation circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a communication system, comprising:
expressing an interaction between a particular user and at least one user in a shared page such that the shared page includes at least one of documents, events, and communications relevant in communications between the particular user and the at least one other user; and
generating the shared page such that the interaction relevant to a communication between the particular user and the at least one user are manifested across a plurality of persona profiles in at least one of activities, events, and communications associated with in the shared page.

2. The method of claim 1 further comprising embedding any groups and users common to the particular user and the at least one user through an nth-degree separation in the shared page, and displaying a relationship simultaneously in the shared page.

3. The method of claim 2 further comprising customizing the shared page based on a relationship modality of the particular user with other users based on a specialized facet, determined based on a behavior and association of the particular user including a family facet having a family relationship constructor, a work facet having an organization chart constructor, and a social facet having an activity classifier to enable the particular user to manifest specialized facets in context of a particular scenario of communications.

4. The method of claim 1 further comprising generating a set of private notes of the particular user about the at least one user in a relationships annotation module associated and linked with the shared page.

5. The method of claim 1 further comprising organizing a preferred ranking of specific documents, events, and communications relevant in communications between the particular user and at least one other user, based on at least one of a behavior of the particular user and a feedback rating provided of the particular user by other parties.

6. The method of claim 1 further comprising generating a digest of relevant sections of the specific communications such that the relevant sections capture a critical message of communication between the particular user and at least one other user including at least one of a subject-line less message and a last paragraph text.

7. The method of claim 1 further comprising determining a segmentible calendar in the shared page that illustrates visually interaction solely between the particular user and combination of at least one user and non-users.

8. The method of claim 1 in which the shared page is filterable based on a temporal criteria specified by the particular user across a plurality of granularities, time zones, and daily routines.

9. The method of claim 1 further comprising alternating between the shared page and other shared pages while maintaining a relationship between the particular user and at least one other user which is independent of any one of the persona profiles currently utilized.

10. The method of claim 1 further comprising shuffling a priority order in the shared page based on feedback ratings, calculated through intelligence gathered from personal representation of the particular user to other users, perception of the other users, behavior analysis of the particular user and linked other users through a relationship behavior compounding algorithm, and collective contact rating of peers.

11. The method of claim 10 further comprising enabling facets through the feedback ratings that are created through implicit and explicit techniques based on at least one of trust, affinity, and propensity of interaction and in which multiple facets coexist in each persona profile and which develop a set of rankings of the particular user with the other users through each of the facets.

12. The method of claim 1 further comprising generating a life map in the shared page of the particular user and at least one other user in which differing activities and behaviors of the particular user are simultaneously expressed in the shared page.

13. The method of claim 12 further comprising organizing the life map around at least one common marker selected between at least one of people communications, events, groups, places, messages, money, and content including music, books, and news feeds.

14. The method of claim 13 further comprising expressing a faceted and fragmented identity of the particular user through each of the persona profiles in which a context is provided to each social interaction of the particular user with the at least one other user.

15. A communications system comprising:
a network;
a plurality of content modules each having an embedded communication module to manage relationships between a user and other users of each of the plurality of content modules; and
a shared context module in a management module to communicate through the network with the plurality of content modules and to generate a shared page having captured interaction in each of the content modules between a particular user and at least one other user based on a behavior of the particular user associated with each of the plurality of content modules with the at least one other user through an analysis of self expressed and peer expressed feedback.

16. The communications system of claim 15 further comprising a feedback module of the management module to analyze intelligence gathered from personal representation of the particular user to other users, perception of the other users, behavior analysis of the user and linked other users through a relationship behavior compounding algorithm, and collective contact rating of peers to determine an order of display of a unitary user profile in the management module of each of groups in the embedded communication module.

17. The communications system of claim 15 further comprising a vault module in which an invisible communication group is viewable simultaneously with a confidential communication group and a public communication group through a multi-layer authentication technique enabled through the management module.

18. A method of a content module, comprising:
enabling expression of a persona of a user in the content module;
associating with the persona specific contacts and groups associated with user's behaviors, activities, and preferences in the content module; and
generating a shared page between the user and at least one other user across different ones of the persona with a management module that generates relationships of the user across a plurality of the content module through the shared page in which each relationship is independent of the persona currently being expressed and which is common across past, current, and future content modules.

19. The method of claim 18 further comprising providing a feedback rating through intelligence gathered from personal representation of the user to other users, perception of the other users, behavior analysis of the user and linked other users through a relationship behavior compounding algorithm, and collective contact rating of peers.

20. The method claim 18 in a form of a machine-readable medium embodying a set of instructions that, when executed by a machine, causes the machine to perform the method of claim 18.
